(19) United States
(12) Patent Application Publication
(10) Pub. No.: US 2022/0405827 A1
(43) Pub. Date: Dec. 22, 2022

(54) PLATFORM FOR SOLICITING, PROCESSING AND MANAGING COMMERCIAL ACTIVITY ACROSS A PLURALITY OF DISPARATE COMMERCIAL SYSTEMS

(71) Applicant: Voxie Inc., Wilmington, DE (US)

(72) Inventors: Ionut Bogdan Constantin, Atlanta, GA (US); Mikhail Avady, Atlanta, GA (US)

(21) Appl. No.: 17/762,826

(22) PCT Filed: Sep. 28, 2020
(86) PCT No.: PCT/US20/53044

§ 371 Date: Mar. 23, 2022

Related U.S. Application Data
(60) Provisional application No. 62/906,254, filed on Sep. 26, 2019.

(51) Int. Cl. G06Q 30/06; G06Q 20/40; H04L 51/02

(52) U.S. Cl. CPC G06Q 30/0633; G06Q 20/401; H04L 51/02

(57) ABSTRACT

The present disclosure provides a platform for soliciting, processing and managing commercial activity across a plurality of disparate commercial systems. The platform may be configured to engage consumers via electronic form of communication, such as, but not limited to, text, SMS, MMS, and email, by engaging the consumer in a bi-directional conversation between the consumer and a computerized agent associated with the platform. The computerized agent may act, in a way, as the consumers commercial agent, suggesting and fulfilling orders from a plurality of disparate commercial platforms on behalf of the consumer through the use of conversational dialog.

### RELATED APPLICATIONS

The present application is a U.S. National Stage under 35 U.S.C. § 371 of International Application No. PCT/US20/53044 filed on Sep. 28, 2020, which claims benefit under the provisions of 35 U.S.C. § 119(e) of U.S. Provisional Application No. 62/906,254 filed on Sep. 26, 2019, and having inventors in common, which are hereby incorporated by reference in their entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to facilitating, via a conversional medium employing a natural language processing means, commercial activity across a plurality of disparate commercial systems.

### BACKGROUND

Conventional systems and strategies for facilitating commercial activity and engaging customers and prospective consumers includes, for example, the use of online advertisement campaigns and email campaigns leading the customer to retail stores or websites. These systems rely upon the consumer to engage the retailer through those conventional mediums, which are increasingly becoming discarded by consumers as email spam or undesirable click-bate advertisements. Furthermore, engaging customers over the telephone with robotic callers is falling in success rate.

The conventional strategy of engaging consumers via websites fails to create real relationships on their preferred communication channel. This often causes problems because the conventional strategy does not provide conversations that feel human, turn conversations into revenue, re-engage with past customers, and encourage repeat purchase.

Accordingly, new platforms through underutilized mediums need to be engaged by retailers to quickly build authentic relationships with their customers and prospective consumers.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present disclosure may provide methods, systems, and computer readable media configured for:
receiving a plurality of campaign parameters for soliciting at least one offer to a plurality of consumers;
identifying, based on the plurality of campaign parameters, at least one consumer of the plurality of consumers to which the at least one offer is to be solicited; polling a plurality of commerce systems to identify at least one offer to be presented to an identified consumer;
receiving offer creation parameters for the at least one offer from at least one commerce system of the plurality of commerce systems;
determining whether the identified consumer qualifies for the at least one offer based on a comparison of a plurality of variables, the plurality of variables comprising at least one of the following: the consumer profile, the campaign parameters, and the at least one offer;
communicating the at least one offer to the identified consumer upon qualification, wherein communicating comprises employing natural language conversational dialog via a bi-directional messaging medium, to engage the consumer and present the at least one offer to the consumer via the natural conversational dialog;
ascertaining that the identified consumer desires to accept the at least one offer, wherein ascertaining that the identified consumer desires to accept the at least one offer comprises ascertaining acceptance through natural language processing of the natural conversational dialog with the identified consumer;
creating, upon ascertaining acceptance, an order associated with the at least one offer, wherein creating the order comprises at least one of the following:
   identifying a commerce system associated with the at least one offer,
   determining order parameters to be provided to the commerce system associated with the at least one offer, and
   receiving the order parameters from at least one of the following:
      a database associated with the plurality of commerce systems, and
      the identified consumer through the conversational means;
processing the order, wherein processing the order further comprises at least one of the following:
presenting the identified consumer, via the natural language conversational dialog over the bi-directional messaging medium, with the order parameters, and
ascertaining from the identified consumer, via the natural language conversational dialog over the bi-directional messaging medium, a confirmation from the consumer;
determining whether payment information is available for the identified consumer;
obtaining, via the natural language conversational dialog over the bi-directional messaging medium, payment information when it is not available;
obtaining payment information associated with the consumer from a database in operative communication with the platform when it is available;
verifying the payment was successful with the payment platform,
when the payment is not successful, notifying the consumer via the natural language conversational dialog over the bi-directional messaging medium, requesting new payment info via the natural language conversational dialog over the bi-directional messaging medium,
ascertaining new payment info via the natural language conversational dialog over the bi-directional messaging medium, and repeating payment verification; and
confirming the consumer payment has been processed, wherein confirming the consumer payment has been processed comprises the following:
   providing the consumer with a confirmation message, via the natural language conversational dialog over the bi-directional messaging medium, comprising order and payment details, and
   tracking the fulfillment of the order, wherein tracking the fulfillment of the order further comprises:
      communicating the fulfillment of the order to the commerce system for at least one of pick, pack and ship actions,
      receiving updates from the commerce system, and
      notifying, via the natural language conversational dialog over the bi-directional messaging medium, the consumer of the at least one of pick, pack and ship action.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of the platform consistent with the present disclosure in detail;

FIG. 2 illustrates one possible embodiment of an advertising campaign over electronic messaging platform provided by a platform consistent with the present disclosure;

FIG. 3 illustrates one possible embodiment of analytics provided by a platform consistent with the present disclosure;

FIG. 4 is a flow chart of a method for providing a platform for facilitating creating, processing and fulfilling orders for an unaffiliated commerce system;

FIG. 5 is a flow chart of a method for providing a platform for facilitating creating, processing and fulfilling orders for an unaffiliated commerce system;

FIG. 6 is a flow chart of a method for providing a platform for facilitating creating, processing and fulfilling orders for an unaffiliated commerce system; and

FIG. 7 is a block diagram of a system including a computing device for performing at least a portion of some methods disclosed herein.

### DETAILED DESCRIPTION

As a preliminary matter, it will readily be understood by one having ordinary skill in the relevant art that the present disclosure has broad utility and application. As should be understood, any embodiment may incorporate only one or a plurality of the disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of processing orders via SMS messaging, embodiments of the present disclosure are not limited to use only in this context.

I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

To address the problems of conventional systems and strategies, the present disclosure provides a platform for soliciting, processing and managing commercial activity across a plurality of disparate commercial systems. The platform may be configured to engage consumers via electronic form of communication, such as, but not limited to, text, SMS, MMS, and email, by engaging the consumer in a bi-directional conversation between the consumer and a computerized agent associated with the platform. The computerized agent may act, in a way, as the consumers commercial agent, suggesting and fulfilling orders from a plurality of disparate commercial platforms on behalf of the consumer through the use of conversational dialog.

The platform may be operated on behalf of one or more retailers or business-to-business providers, professional services firms, eCommerce brands or consumer package goods brands (hereinafter referred to as the “platform operator”). The platform may be configured to be in operative communication with a plurality of commercial systems such as, for example, CRMs, retail systems, payment processors, and ERP systems, payment gateways, online marketplaces, affiliate networks, third-party merchants, reward and loyalty system, event management systems and travel and transportation systems (hereinafter referred to as the “commerce system”). In some embodiments, the platform may integrate into one or more of such commercial systems. These systems may or may not be affiliated with the platform or platform operator.

The platform may coordinate offer creation, delivery, confirmation of payment and all communications between the following: a product provider/unaffiliated commerce system, such as, by way of non-limiting examples, Walmart, Target, Amazon and Flowers.com; a payment processor, such as, by way of non-limiting examples, Square Cash, PayPal, Visa, MasterCard, Stripe and BitPay; and the consumer that may be interested in at least one product offered by at least one product provider/unaffiliated commerce system.

Furthermore, the platform may utilize a digital messaging service, such as, but not limited to SMS, MMS, text message and email services, in order to facilitate the coordination of e-commerce transactions. The transactions may be between at least one consumer and at least one commerce system. The transactions may be processed by a payment processor chosen by the consumer and/or commerce system. In some embodiments, the platform may facilitate the transactions without storing any consumer personal data and payment data. Furthermore, the platform may be configured to facilitate the transactions without asking the consumer to input personal data and payment data more than once per payment platform used.

The platform of the present disclosure may be employed by platform operators to maintain contact with their customers and prospective consumers (e.g., the end-users) through bi-directional communication. In some embodiments, the platform may comprise a chatbot for bi-directional communication. In some embodiments, the chatbot may utilize natural language processing modules to facilitate the bi-directional communication. In some embodiments, the bi-directional communication is automated through a decision tree process. In yet further embodiments, the chatbot may be utilize artificial intelligence and machine learning modules. Through these functions, the bi-directional communication may be designed to feel human, providing the end-users with a human-like and personalized experience.

By way of non-limiting example, the platform may engage an identified consumer on behalf of the platform operator. The identified consumer may be, for example, identified by way of manual input by the platform operator. In some embodiments, the platform may be configured to identify one or more consumers based on target consumer profiles established by the platform operator, and a comparison of available consumer data (e.g., online behavioral data) to the specified target consumer profiles. In yet further embodiments, the consumer may be identified as an existing customer, with available customer data tracked and monitored by the platform. The available consumer data may be matched against certain rules or parameters to identify an appropriate time, channel, and solicitation with which to engage the customer. In yet further embodiments, a combination of one or more of the aforementioned methods may be used in an engagement campaign specified by the platform operator.

Having identified the consumer, the platform may employ a computerized agent such as, but not limited to, an AI chatbot, to initiate a dialog with the identified consumer. The dialog may be based on a particular engagement campaign or other parameters specified by the platform operator. For example, the platform, by way of computing means, may have determined that the identified consumer is a recurring purchaser of tea products, and a period of time has lapsed since the consumer's last purchase of tea. In turn, the AI chatbot may engage the consumer through a medium, such as, but not limited to, a SMS message to the consumer's mobile device. The message may solicit a purchase of tea from the consumer through natural, conversational means. The consumers responses to the AI chatbot may be provided back to the platform. In turn, the platform may be configured to ascertain instructions with regard to the purchase of the tea products on behalf of the consumer, and the fulfillment of the order from one or more commerce systems in operative communication with the platform. Details for these methods and systems are provided below.

In some embodiments, the platform may create, process, and fulfill orders, initiated from an ad unit, social post, or QR code by engaging conversation with one simple action by the consumer. In some embodiments, the platform may engage the consumer without any actions by the consumer. In some embodiments, the platform may re-engage and follow up with consumers that have used the platform before.

In some embodiments, the platform may utilize a communication method preferred by the consumer. The preferred communication method may comprise email, SMS, MMS, and text messaging by a non-limiting example. By utilizing a communication method preferred by the consumer, such as SMS or other form of direct or instant messaging, the platform may significantly increase conversion rates of turning leads and reach brand new audiences for unaffiliated commerce systems. Furthermore, by utilizing the preferred communication method, the platform may provide a platform operator (e.g., a commerce user) with an ability to leverage a plurality of disparate commerce systems and engage in a conversational dialog with a consumer to quickly build real relationships with their customers, maximizing brand and retailer loyalty.

In some embodiments consistent with the present disclosure, the platform may provide an administrative interface for interfacing with the platform as well as disparate commerce systems. In some embodiments, the administrative interface may provide an ability for a commerce user to create/modify/delete relationship campaigns that may be configured to leverage the plurality of disparate commerce systems. In some embodiments, the administrative interface may provide an ability for the commerce user to create/modify/delete follow up campaigns.

In some embodiments consistent with the present disclosure, the platform may provide an analytics interface to a commerce user. In some embodiments, the analytics interface may provide analytics data to the commerce user, such as, but not limited to, average response rate of consumers, average click through rate of consumers, and average offer opening rate of consumers.

Embodiments of the present disclosure may comprise methods, systems, and a computer readable medium comprising, but not limited to, at least one of the following:

A. A Consumer Communication Module;

B. A Commerce System Communication Module;

C. A Payment Processing Module;

D. An Admin Interface Module; and

E. An Analytics Module.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each stage disclosed within each module can be considered independently without the context of the other stages within the same module or different modules. Each stage may contain language defined in other portions of this specifications. Each stage disclosed for one module may be mixed with the operational stages of another module. In the present disclosure, each stage can be claimed on its own and/or interchangeably with other stages of other modules.

The following depicts an example of a method of a plurality of methods that may be performed by at least one of the aforementioned modules. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, server and/or computing device 700 may be employed in the performance of some or all of the stages disclosed with regard to the methods. Similarly, an apparatus may be employed in the performance of some or all of the stages of the methods. As such, the apparatus may comprise at least those architectural components as found in computing device 700.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the aforementioned modules. The method may be embodied as, for example, but not limited to, computer instructions, which when executed, perform the method. The method may comprise the following stages.

In some stages, the platform modules may be configured for receiving a plurality of campaign parameters for soliciting at least one offer to a plurality of consumers.

In some stages, the platform modules may be configured for identifying, based on the plurality of campaign parameters, at least one consumer of the plurality of consumers to which the at least one offer is to be solicited.

In some stages, the platform modules may be configured for Polling a plurality of commerce systems to identify at least one offer to be presented to an identified consumer.

In some stages, the platform modules may be configured for receiving offer creation parameters for the at least one offer from at least one commerce system of the plurality of commerce systems.

In some stages, the platform modules may be configured for determining whether the identified consumer qualifies for the at least one offer based on a comparison of a plurality of variables, including, but not limited to: the consumer profile, the campaign parameters, and the at least one offer.

In some stages, the platform modules may be configured for communicating, the at least one offer to the identified consumer upon qualification. The stages of communicating may comprise employing conversational dialog to engage the consumer and present the at least one offer to the consumer via conversational means. Furthermore, the conversational dialog may comprise an instant messaging bi-directional communication.

In some stages, the platform modules may be configured for determining that the identified consumer desires to accept the at least one offer. The stages of determining that the identified consumer desires to accept the at least one offer may comprise ascertaining acceptance through natural language processing of the conversation with the identified consumer.

In some stages, the platform modules may be configured for creating, upon ascertaining acceptance, an order associated with the at least one offer. The stages of creating the order may comprise at least one of the following sub-stages: identifying a commerce system associated with the at least one offer, determining order parameters to be provided to the commerce system associated with the at least one offer, and receiving the order parameters. In some sub-stages, the order parameters may be received from at least one of the following: a database associated with the plurality of commerce systems, and the identified consumer through the conversational means.

In some stages, the platform modules may be configured for processing the order. The stages of processing the order may further comprise at least one of the following substages: presenting the identified consumer with the order parameters for fulfillment; receiving a confirmation from the consumer; providing a hyperlink to a payment platform associated with the order; receiving a selection of the hyperlink from the consumer indicating navigation to the link; and processing a payment associated with the consumer. In some sub-stages, if the consumer is new to the platform, the platform may require payment information from consumer. Else, if the consumer is not new the platform, the platform modules may be configured for obtaining payment information associated with the consumer from a database in operative communication with the platform. Continuing, the platform modules may be configured for verifying the payment was successful with the payment platform. If the payment is not successful, the platform modules may be configured to notify all parties involved; receive new payment credentials and repeat the verification process. Upon success, the platform modules may be configured for confirming the consumer payment has been processed. The stages of confirming the consumer payment has been processed may further comprise: providing the consumer with a confirmation page comprising order and payment details, and sending a confirmation message to the consumer.

In some stages, the platform modules may be configured for fulfilling the order, wherein fulfilling the order may further comprise at least one the following sub-stages: communicating the fulfillment of the order to the commerce system for at least one of pick, pack and ship actions, receiving updates from the commerce system, and notifying, through the conversational means, the consumer of the at least one of pick, pack and ship actions.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

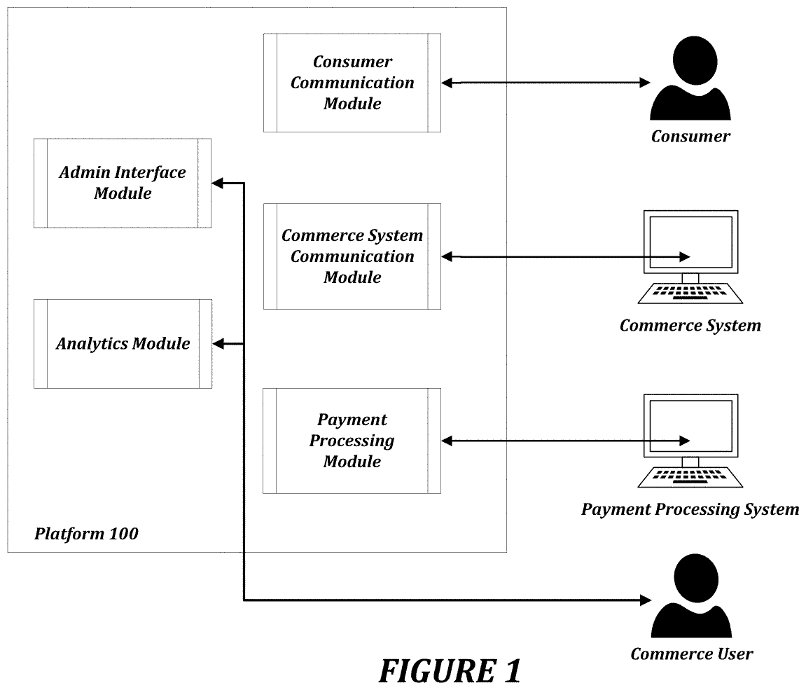

FIG. 1 illustrates one possible operating environment through which a platform consistent with embodiments of the present disclosure may be provided. By way of non-limiting example, a platform for facilitating creating, processing and fulfilling orders for an unaffiliated commerce system (platform 100) may be hosted on, for example, a cloud computing service. In some embodiments, platform 100 may be hosted on a server. A user may access platform 100 through a software application. The software application may be embodied as, for example, but not be limited to, a website, a web application, a desktop application, and a mobile application compatible with a computing device 700. One possible embodiment of the software application may be provided by the conversational marketing suite of products and services provided by Voxie Ventures LLC, available at voxie.com.

Accordingly, embodiments of the present disclosure provide a software and hardware platform comprised of a distributed set of computing elements, including, but not limited to, the following modules.

A. A Consumer Communication Module

In some embodiments consistent with the present disclosure, a consumer communications module may be provided. The consumer communications module may facilitate all communications between the platform 100 and the consumer.

In some embodiments consistent with the present disclosure, the consumer communication module may be configured to integrate with or operate in conjunction with at least one digital messaging service, such as, but not limited to, an SMS, MMS, or other digital instant messaging medium (e.g., WhatsApp, Facebook Chat, Instagram Chat, WeChat, and other forms of electronic commutation). The consumer communications module may employ these platforms in order to facilitate conversation dialog with consumers and, via the dialog, serve as a point of coordination for e-commerce transactions. In some embodiments, the consumer communications module may facilitate the transactions without storing any consumer personal data and payment data. In some embodiments, the consumer communications module may facilitate the transactions without asking the customer to input personal data and payment data more than once per payment platform used.

In some embodiments consistent with the present disclosure, the consumer communications module may build authentic one on one relationships with the consumers through bi-directional communication. In some embodiments, the consumer communications module may utilize natural language processing for bi-directional communication. In some embodiments, the consumer communications module may comprise an AI chatbot for bi-directional communication. In some embodiments, the bi-directional communication is designed to feel human. In some embodiments, the bi-directional communication is automated.

In some embodiments, the platform 100 may create, process, and fulfill orders, initiated from an ad unit, social post, or QR code by engaging conversation with one simple action by the consumer. The engaging in conversation may be provided by the consumer communications module. In some embodiments, the consumer communications module may engage the consumer without any actions by the consumer. In some embodiments, the consumer communication module may re-engage and follow up with consumers that have used the platform before. In some embodiments, the AI Chatbot may be enabled to detect the consumer's activity (or lack thereof) and propose adjustments to the consumer's commercial activity. For instance, as one example, the AI Chatbot may propose pausing a subscription for a user. The proposal may be performed through a conversational dialog such as, for illustrative purposes, the following discussion: “Hey I noticed you did not use our product last month, want me to pause your subscription for next month?” or “Hey if you don't want us to send you your monthly product this month text pause.” The consumer may reply with natural language to elect an option.

In some embodiments, the consumer communication module may utilize a communication method preferred by the consumer. The preferred communication method may comprise any form of electronic commutation, including, but not limited to, text messaging or other forms of direct messaging. By utilizing a communication method preferred by the consumer, the consumer communication module may provide an ability for unaffiliated commerce systems to quickly build real relationships with their customers, maximizing brand and retailer loyalty by communicating with the consumers in a natural, and human way.

It should be understood that, throughout the various embodiments, the platform may be disclosed to extend an offer to a consumer for engaging in a commercial activity. However, in some embodiments, the consumer may request an offer from the platform, using the same conversational dialog means. For instance, the user may, without solicitation, initiate a request for the purchase of a product without having received the offer for the product for the platform. In such embodiments, the platform may operate in the same manner as if the offer was presented to the user by the platform. Furthermore, the user may be enabled to change an order. For example, the user may text “BUY” to get this t-shirt or “COLOR” to change the color of the shirt. Further still, the user may text color and then on the next message text buy to make the transaction. Accordingly, the platform modules, in conjunction, may facilitate a test-messaging based specification, offer, negotiation, and acceptance.

B. A Commerce System Communication Module

In some embodiments consistent with the present disclosure, a commerce system communication module may be provided. The commerce system communications module may facilitate communication between the platform 100 and a plurality of commerce systems. The commerce systems may comprise commerce systems that are not affiliated with the platform. The commerce systems may comprise commerce systems, such as, but not limited to Walmart, Target, Amazon and Flowers.com.

In some embodiments consistent with the present disclosure, the commerce system communication module may poll the plurality of commerce systems for at least one request for creating, processing, and fulfilling. In some embodiments, the commerce system communications module may communicate the fulfillment of the order to the commerce system of the at least one of pick, pack and ship actions for the fulfillment of at least one request. In other embodiments, the payment processing system may communicate the fulfillment of the order to the commerce system for at least one of pick, pack and ship actions.

In some embodiments consistent with the present disclosure, the commerce system communication module may receive offer creation parameters for at least one request from at least one commerce system. In some embodiments, the offer creation parameters may comprise, but not be limited to, cost, available quantity, color, size, pattern, description, specifications, etc.

Consistent with embodiments of the present disclosure, the commerce system communications module may be configured to communicate with the plurality of disparate commerce systems using, for example, but not limited to, various technical integrations such as application programming interfaces, customer software development kits, and other bi-directional communication methods and systems. In some embodiments, the commerce system may be affiliated with a platform administrator.

The commerce system communications module may be configured to receive and process the inventory, pricing, delivery, and all other commerce related parameters. In this way, platform 100 may be configured to ascertain a plurality of product and services to offer to a plurality of consumers. In some embodiments, platform 100 may generate a lexicon of products and services so as to determine which consumers, based on consumer characteristics that it may derive or obtain, are best qualified and most likely to accept the products and service offerings.

C. A Payment Processing Module

In some embodiments consistent with the present disclosure, a payment processing module may be provided. The payment processing module may facilitate payments by integrating with a payment processing platform, such as, but not limited to, unaffiliated payment processing platform. By a non-limiting example, the payment processing module may integrate with a payment processor, such as at least one of Square Cash, PayPal, Visa, MasterCard, Stripe and BitPay.

In some embodiments consistent with the present disclosure, the payment processing module may facilitate payments without storing any consumer data, such as, but not limited to personal consumer information and payment information. In some embodiments, the payment processing module may generate a payment link to be provided to the consumer via consumer communication module. In some embodiments, the payment processing platform may require new users to register with the payment platform. In some embodiments, the registration may require the consumer to enter information, such as, but not limited to, personal information and payment information. In some embodiments, the consumer does not need to enter any information after successful registration with the payment platform.

In some embodiments consistent with the present disclosure, the payment platform may provide the consumer to provide a plurality of payments methods. In some embodiments, the payment processing module may provide the consumer an ability to choose the preferred payment method from the plurality of payment methods via consumer communication module. In some embodiments, the consumer may choose a default payment method. In some embodiments, fulfilling the order may not require additional customer intervention when a default payment method is selected.

In some embodiments consistent with the present disclosure, the payment processing module may handle failed payments. In some embodiments, the payment processing module may notify the consumer of the failed payment via consumer communications module. In some embodiments, the payment processing module may receive new payment information from the consumer. In some embodiments, the payment processing module may provide the ability for the consumer to enter new payment information via consumer communications module. In some embodiments, the aforementioned ability is provided with a link to the payment processing system.

D. An Admin Interface Module

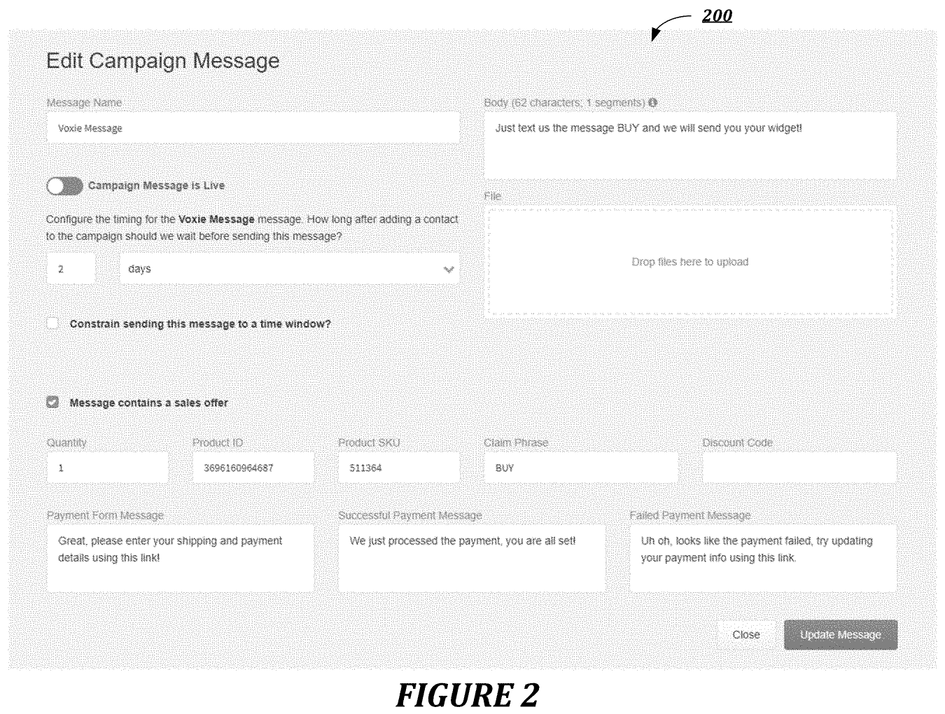

An Admin Interface Module may be provided. In some embodiments, platform 100 may provide an administrative interface for unaffiliated commerce systems. In some embodiments, the administrative interface may provide an ability for a commerce user to create/modify/delete advertising campaigns. In some embodiments, the administrative interface may provide an ability for the commerce user to create/modify/delete follow up campaigns. One possible non-limiting embodiment is depicted as interface 200 in FIG. 2.

In some embodiments consistent with the present disclosure, the campaigns may be automated. In some embodiments, the commerce user may select a plurality of configuration options associated with an automated campaign. The following are non-limiting examples of configuration options for an automated campaign:
Message Name—The name given to the current automated campaign in order to distinguish from a plurality of automated campaigns.
Campaign Message is Live—Whether the current campaign is currently active.
Body—The body of the message. The body may comprise, but not limited to, message to a consumer, audio and/or visual media, AI generated content, file attachments and links.
Message Delay—Configure timing for an automated message campaign. The message delay may comprise, but not limited to, a time delay between adding a contact and sending a first message.
Time Window Constraint—The time window during which the automated campaign may be active.
Sales Offer—An indication whether the message may contain a sales offer to be provided to a consumer.
Offer Parameters—In some embodiments, the indication of a sales offer may also provide offer creation parameters. The offer creation parameters may comprise, but not limited to the following:
   Quantity
   Product ID
   Product SKU
   Claim Phrase
   Discount Code
   Payment Form Message
   Successful Payment Message
   Failed Payment Message

Still consistent with embodiment of the present disclosure, platform 100 may be configured to receive a specification of communications medium to be used for communicating with a consumer (e.g., via consumer communications module). Furthermore, platform 100 may further be configured to receive a specification of what consumer type to communicate, based on desired demographical, behavioral, psychographic, and various other characteristics and propensity traits that may be attributed to the consumer.

Further still, platform 100 may be configured to receive a specification of the products or service offerings it is to serve to the consumer (e.g., via consumer communications module). In some embodiments, platform 100 may be integrated with a CRM such as, for example, but not limited to, Salesforce, MailChimp, HubSpot, and any other customer and messaging campaign management platform. In yet further embodiments, platform 100 may be configured to identify a list of prospective consumers based on the products in service offerings.

E. An Analytics Module

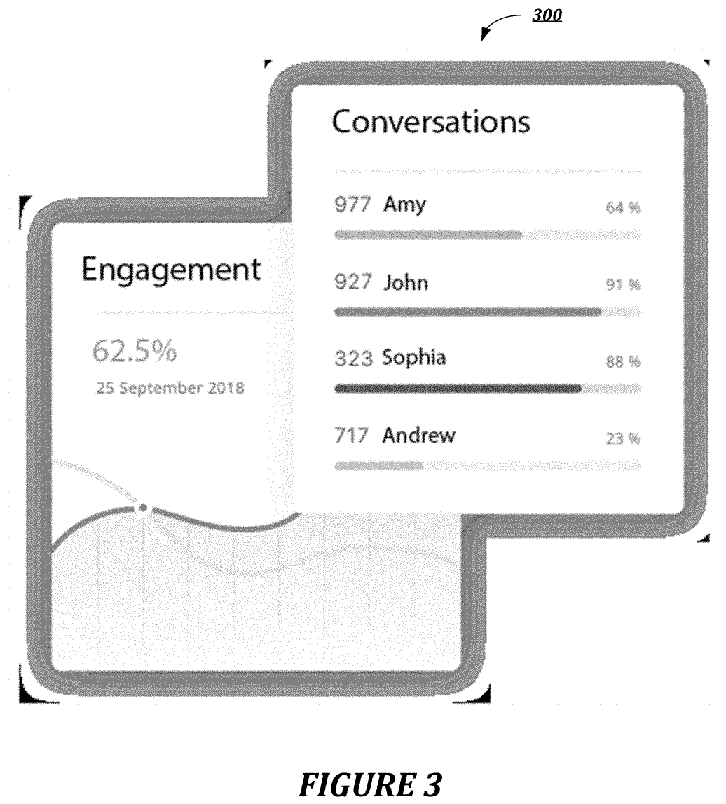

In some embodiments consistent with the present disclosure, the platform 100 may provide an analytics interface to a commerce user. In some embodiments, the analytics interface may provide analytics data to the commerce user, such as, but not limited to, average response rate of consumers, average click through rate of consumers, and average offer opening rate of consumers. FIG. 3 illustrates a non-limiting embodiment of an analytics interface 300.

In some embodiments consistent with the present disclosure, the analytics module may provide analytics data associated with consumers to the commerce user. In some embodiments, the analytics data may comprise data sets associated with each customer. In some embodiments, the analytics module may perform a math operation on the data sets, such as, but not limited to, average, highest, and lowest. In some embodiments, the data sets may comprise, but not limited to average response rate, average clickthrough rate, and open rate.

Still consistent with embodiments of the present disclosure, platform 100 may integrate with an aforementioned CRM (e.g., Salesforce, MailChimp, HubSpot, and the like) and provide the analytics therein.

III. Platform Operation

Embodiments of the present disclosure provide a hardware and software platform operative by a set of methods and computer-readable media comprising instructions configured to operate the aforementioned modules and computing elements in accordance with the methods. The following depicts an example of a method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, server and/or computing device 700 may be employed in the performance of some or all of the stages disclosed with regard to the methods. Similarly, apparatus may be employed in the performance of some or all of the stages of the methods. As such, apparatus may comprise at least those architectural components as found in computing device 700.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

A. Order Fulfillment Method

Consistent with embodiments of the present disclosure, a method may be performed by at least one of the aforementioned modules. The method may be embodied as, for example, but not limited to, computer instructions, which when executed, perform the method.

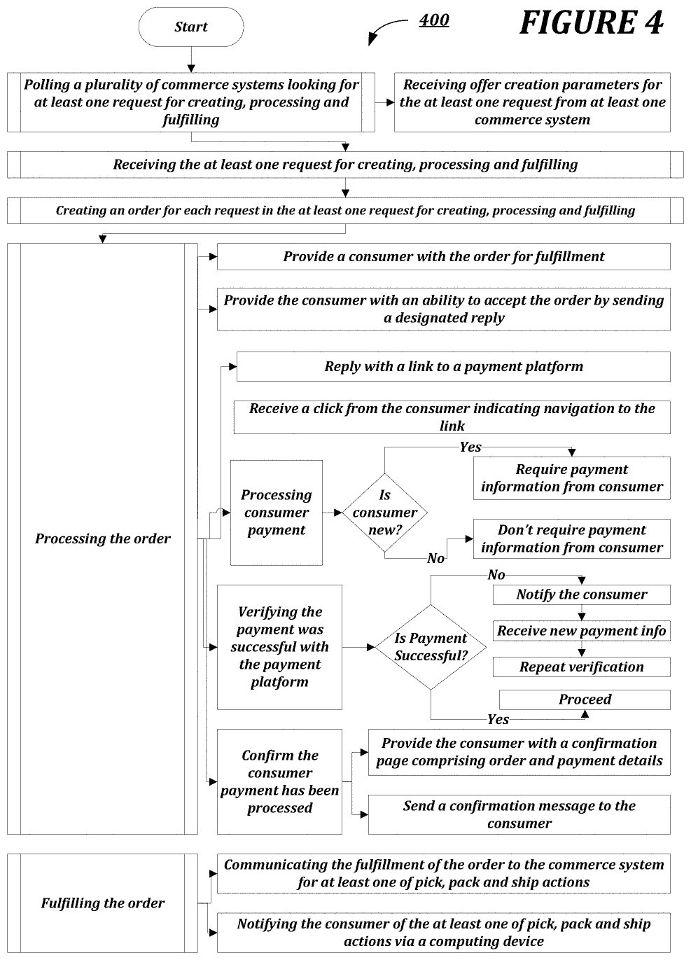

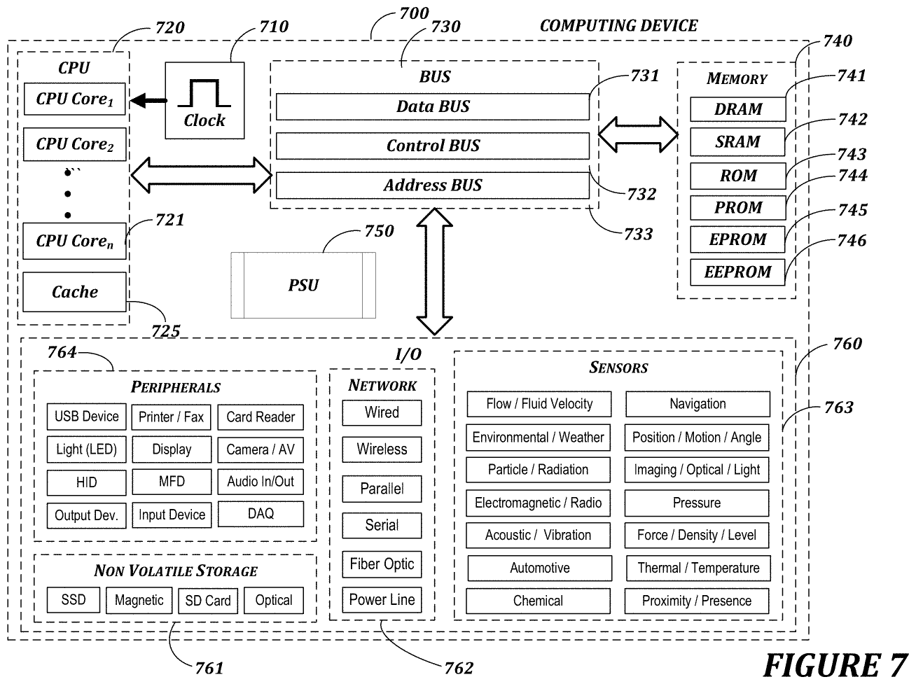

FIG. 4 is a flow chart setting forth the general stages involved in a method 400 consistent with an embodiment of the disclosure for providing platform for facilitating creating, processing and fulfilling orders for an unaffiliated commerce system (platform 100). Method 400 may be implemented using a computing device 700 or any other component associated with platform 100 as described in more detail below with respect to FIG. 7. For illustrative purposes alone, computing device 700 is described as one potential actor in the follow stages.

In some stages, method 400 may poll a plurality of commerce systems looking for at least one request for creating, processing and fulfilling; wherein, polling comprises receiving offer creation parameters for the at least one request from at least one commerce system.

In some stages, method 400 may then receive the at least one request for creating, processing and fulfilling.

In some stages, method 400 may proceed to create an order for each request in the at least one request for creating, processing and fulfilling.

In some stages, method 400 may then begin processing the order; wherein processing the order may further comprise at least one of the following:
1. Providing a consumer with the order for fulfillment,
2. Replying with a link to a payment platform,
3. Receiving a click from the consumer indicating navigation to the link, and
   a. Processing consumer payment, and if the consumer is new, requiring payment information from consumer, and
   b. If the consumer is not new, not requiring payment information from consumer.

In some stages, method 400 may next verify the payment was successful with the payment platform. If the payment is not successful, method 400 may be configured for notifying the consumer, receiving new payment info, and repeating verification. For successful payment, method 400 may be configured for confirming the consumer payment has been processed, wherein confirming the consumer payment has been processed comprises at least one of the following: providing the consumer with a confirmation page comprising order and payment details, and sending a confirmation message to the consumer.

In some stages, method 400 may proceed with fulfilling the order, wherein fulfilling the order further comprises at least one of the following: communicating the fulfillment of the order to the commerce system for at least one of pick, pack and ship actions, and notifying the consumer of the at least one of pick, pack and ship actions via a computing device.

B. Consumer Method

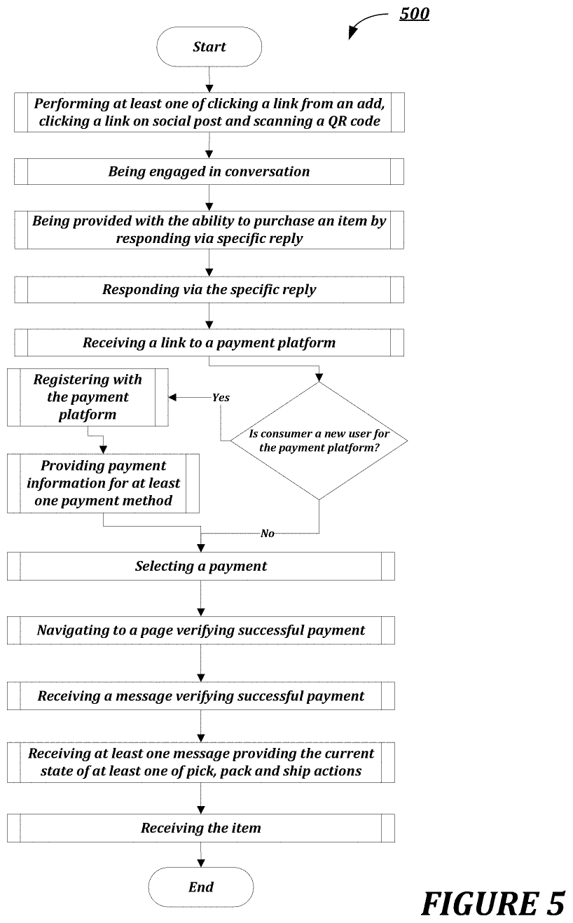

FIG. 5 is a flow chart setting forth the general stages involved in a method 500 consistent with an embodiment of the disclosure for providing platform for facilitating creating, processing and fulfilling orders for an unaffiliated commerce system (platform 100). Method 500 may be implemented using a computing device 700 or any other component associated with platform 100 as described in more detail below with respect to FIG. 7. For illustrative purposes alone, computing device 700 is described as one potential actor in the follow stages.

Consistent with embodiments of the present disclosure, a method may be performed by at least one of the aforementioned modules. The method may be embodied as, for example, but not limited to, computer instructions, which when executed, perform the method.

In some stages, method 500 may receive an indication that a consumer has at least one of clicking a link from an ad, clicking a link on social post and scanning a QR code.

In some stages, method 500 may, in response to the indication, engage with the consumer in conversation. It should be understood that, in various embodiments, the engagement of conversation may be unsolicited by the consumer but initiated by the platform based on various campaign parameters established by the platform administrator. The engagement may be in the form of, for example, but not limited to, direct or instant, bi-direction, text-based messaging.

In some stages, method 500 may proceed to offer the consumer, via conversation dialog, a product or service for purchase. The consumer may be enabled to reply using natural processing means in order to negotiate specifics of the product or service offerings (e.g., size, color, quantity, time, location, and various other product or service parameters).

In some stages, method 500 may ascertain, via the natural language replies received from the consumer, that the consumer has confirmed an order is to be facilitated.

In some stages, method 500 may then proceed to ascertain, via the natural language dialog, payment credentials. Payment credentials may be required if the platform 100 does not otherwise have access or records of the consumer's payment credentials (e.g., payment processing module). In this case, the consumer's payment information may be obtained, and a payment option would be specified.

In some stages, method 500 may, upon payment input, provide a user with a payment input message. The message may, in some embodiments, comprise a link to a website. The user may be enabled, via the website, to payment information input.

Receiving a message verifying successful payment.

In some stages, method 500 may, upon payment fulfillment, provide a user with a payment fulfillment message.

In some stages, method 500 may continue to communicate with the consumer, to keep the consumer apprised on the current state of at least one pick, pack and ship actions facilitated for the order by platform 100.

In some stages, method 500, the consumer may be enabled to, upon receiving the item, provide product reviews or communicate with the supplier of the product. In this way, platform 100 may employ a natural conversation dialog for customer services issues, such as, but not limited to, technical support or product returns.

C. Administration Method

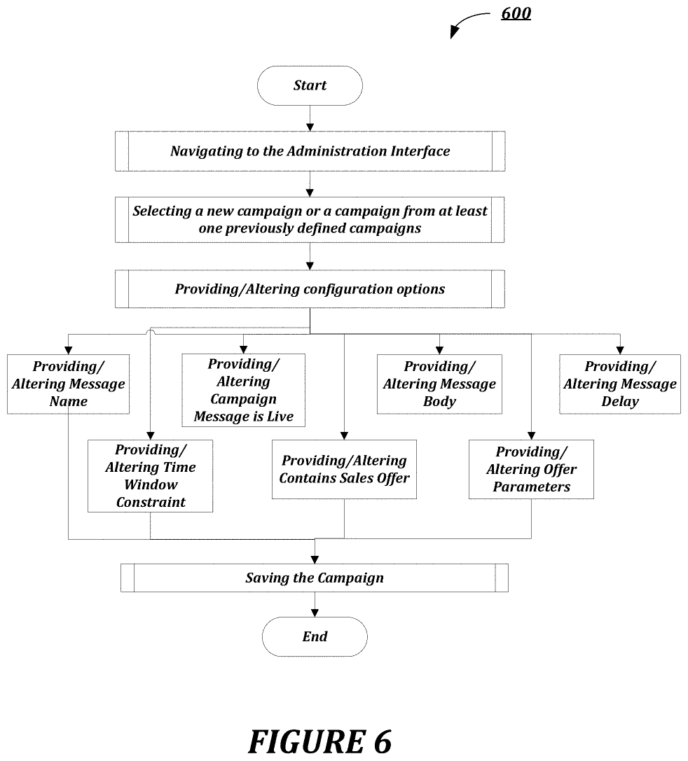

FIG. 6 is a flow chart setting forth the general stages involved in a method 600 consistent with an embodiment of the disclosure for providing platform for facilitating creating, processing and fulfilling orders for an unaffiliated commerce system (platform 100). Method 600 may be implemented using a computing device 700 or any other component associated with platform 100 as described in more detail below with respect to FIG. 7. For illustrative purposes alone, computing device 700 is described as one potential actor in the follow stages.

Consistent with embodiments of the present disclosure, an administration method may be performed by at least one of the aforementioned modules. The method may be embodied as, for example, but not limited to, computer instructions, which when executed, perform the method.

In some stages, method 600 may provide administrative interface 200 to an administrative user.

In some stages, method 600 may then receive a specification of a previously generated campaign or a new campaign. The user may then be configured to specific or otherwise modify various campaign parameters.

The campaign parameters may comprise, but not be limited to, for example, options comprises of the following: names, messaging, consumer types, products/services, integrated platforms, analytics, consumer conversation history, timing parameters, and various other campaign parameters.

IV. Computing Device Architecture

Platform 100 may be embodied as, for example, but not be limited to, a website, a web application, a desktop application, backend application, and a mobile application compatible with a computing device 700. The computing device 700 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device.

Platform 100 may be hosted on a centralized server or a cloud computing service. Although method 500 has been described to be performed by a computing device 700, it should be understood that, in some embodiments, different operations may be performed by a plurality of the computing devices 700 in operative communication over one or more networks.

Embodiments of the present disclosure may comprise a system having a central processing unit (CPU) 720, a bus 730, a memory unit 740, a power supply unit (PSU) 750, and one or more Input/Output (I/O) units. The CPU 720 coupled to the memory unit 740 and the plurality of I/O units 760 via the bus 730, all of which are powered by the PSU 750. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 7 is a block diagram of a system including computing device 700. Consistent with an embodiment of the disclosure, the aforementioned CPU 720, the bus 730, the memory unit 740, a PSU 750, and the plurality of I/O units 760 may be implemented in a computing device, such as computing device 700 of FIG. 7. Any suitable combination of hardware, software, or firmware may be used to implement the aforementioned units. For example, the CPU 720, the bus 730, and the memory unit 740 may be implemented with computing device 700 or any of other computing devices 700, in combination with computing device 700. The aforementioned system, device, and components are examples and other systems, devices, and components may comprise the aforementioned CPU 720, the bus 730, the memory unit 740, consistent with embodiments of the disclosure.

A computing device 700 does not need to be electronic, nor even have a CPU 720, nor bus 730, nor memory unit 740. The definition of the computing device 700 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 700, especially if the processing is purposeful.

With reference to FIG. 7, a system consistent with an embodiment of the disclosure may include a computing device, such as computing device 700. In a basic configuration, computing device 700 may include at least one clock module 710, at least one CPU 720, at least one bus 730, and at least one memory unit 740, at least one PSU 750, and at least one I/O 760 module, wherein I/O module may be comprised of, but not limited to a non-volatile storage sub-module 761, a communication sub-module 762, a sensors sub-module 763, and a peripherals sub-module 764.

A system consistent with an embodiment of the disclosure the computing device 700 may include the clock module 710 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 720, the central component of modern computers, which relies on a clock. The only exceptions are asynchronous circuits such as asynchronous CPUs. The clock 710 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 700 use a “clock multiplier” which multiplies a lower frequency external clock to the appropriate clock rate of the CPU 720. This allows the CPU 720 to operate at a much higher frequency than the rest of the computer, which affords performance gains in situations where the CPU 720 does not need to wait on an external factor (like memory 740 or input/output 760). Some embodiments of the clock 710 may include dynamic frequency change, where, the time between clock edges can vary widely from one edge to the next and back again.

A system consistent with an embodiment of the disclosure the computing device 700 may include the CPU unit 720 comprising at least one CPU Core 721. A plurality of CPU cores 721 may comprise identical the CPU cores 721, such as, but not limited to, homogeneous multi-core systems. It is also possible for the plurality of CPU cores 721 to comprise different the CPU cores 721, such as, but not limited to, heterogeneous multi-core systems, big.LITTLE systems and some AMD accelerated processing units (APU). The CPU unit 720 reads and executes program instructions which may be used across many application domains, for example, but not limited to, general purpose computing, embedded computing, network computing, digital signal processing (DSP), and graphics processing (GPU). The CPU unit 720 may run multiple instructions on separate CPU cores 721 at the same time. The CPU unit 720 may be integrated into at least one of a single integrated circuit die and multiple dies in a single chip package. The single integrated circuit die and multiple dies in a single chip package may contain a plurality of other aspects of the computing device 700, for example, but not limited to, the clock 710, the CPU 720, the bus 730, the memory 740, and I/O 760.

The CPU unit 721 may contain cache 722 such as, but not limited to, a level 1 cache, level 2 cache, level 3 cache or combination thereof. The aforementioned cache 722 may or may not be shared amongst a plurality of CPU cores 721. The cache 722 sharing comprises at least one of message passing and inter-core communication methods may be used for the at least one CPU Core 721 to communicate with the cache 722. The inter-core communication methods may comprise, but not limited to, bus, ring, two-dimensional mesh, and crossbar. The aforementioned CPU unit 720 may employ symmetric multiprocessing (SMP) design.

The plurality of the aforementioned CPU cores 721 may comprise soft microprocessor cores on a single field programmable gate array (FPGA), such as semiconductor intellectual property cores (IP Core). The plurality of CPU cores 721 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 721, for example, but not limited to Instruction-level parallelism (ILP) such as, but not limited to, superscalar pipelining, and Thread-level parallelism (TLP).

Consistent with the embodiments of the present disclosure, the aforementioned computing device 700 may employ a communication system that transfers data between components inside the aforementioned computing device 700, and/or the plurality of computing devices 700. The aforementioned communication system will be known to a person having ordinary skill in the art as a bus 730. The bus 730 may embody internal and/or external plurality of hardware and software components, for example, but not limited to a wire, optical fiber, communication protocols, and any physical arrangement that provides the same logical function as a parallel electrical bus. The bus 730 may comprise at least one of, but not limited to a parallel bus, wherein the parallel bus carry data words in parallel on multiple wires, and a serial bus, wherein the serial bus carry data in bit-serial form. The bus 730 may embody a plurality of topologies, for example, but not limited to, a multidrop/electrical parallel topology, a daisy chain topology, and a connected by switched hubs, such as USB bus. The bus 730 may comprise a plurality of embodiments, for example, but not limited to:

Internal data bus (data bus) 731/Memory bus
Control bus 732
Address bus 733
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (i.e., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 700 may employ hardware integrated circuits that store information for immediate use in the computing device 700, know to the person having ordinary skill in the art as primary storage or memory 740. The memory 740 operates at high speed, distinguishing it from the non-volatile storage sub-module 761, which may be referred to as secondary or tertiary storage, which provides slow-to-access information but offers higher capacities at lower cost. The contents contained in memory 740, may be transferred to secondary storage via techniques such as, but not limited to, virtual memory and swap. The memory 740 may be associated with addressable semiconductor memory, such as integrated circuits consisting of silicon-based transistors, used for example as primary storage but also other purposes in the computing device 700. The memory 740 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 741, Static Random-Access Memory (SRAM) 742, CPU Cache memory 725, Advanced Random-Access Memory (A-RAM), and other types of primary storage such as Random-Access Memory (RAM).
Non-volatile memory which can retain stored information even after power is removed, for example, but not limited to, Read-Only Memory (ROM) 743, Programmable ROM (PROM) 744, Erasable PROM (EPROM) 745, Electrically Erasable PROM (EEPROM) 746 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 700 may employ the communication system between an information processing system, such as the computing device 700, and the outside world, for example, but not limited to, human, environment, and another computing device 700. The aforementioned communication system will be known to a person having ordinary skill in the art as I/O 760. The I/O module 760 regulates a plurality of inputs and outputs with regard to the computing device 700, wherein the inputs are a plurality of signals and data received by the computing device 700, and the outputs are the plurality of signals and data sent from the computing device 700. The I/O module 760 interfaces a plurality of hardware, such as, but not limited to, non-volatile storage 761, communication devices 762, sensors 763, and peripherals 764. The plurality of hardware is used by the at least one of, but not limited to, human, environment, and another computing device 700 to communicate with the present computing device 700. The I/O module 760 may comprise a plurality of forms, for example, but not limited to channel I/O, port-mapped I/O, asynchronous I/O, and Direct Memory Access (DMA).

Consistent with the embodiments of the present disclosure, the aforementioned computing device 700 may employ the non-volatile storage sub-module 761, which may be referred to by a person having ordinary skill in the art as one of secondary storage, external memory, tertiary storage, off-line storage, and auxiliary storage. The non-volatile storage sub-module 761 may not be accessed directly by the CPU 720 without using intermediate area in the memory 740. The non-volatile storage sub-module 761 does not lose data when power is removed and may be two orders of magnitude less costly than storage used in memory module, at the expense of speed and latency. The non-volatile storage sub-module 761 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (761) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UD0).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, and Solid State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 700 may employ the communication sub-module 762 as a subset of the I/O 760, which may be referred to by a person having ordinary skill in the art as at least one of, but not limited to, computer network, data network, and network. The network allows computing devices 700 to exchange data using connections, which may be known to a person having ordinary skill in the art as data links, between network nodes. The nodes comprise network computer devices 700 that originate, route, and terminate data. The nodes are identified by network addresses and can include a plurality of hosts consistent with the embodiments of a computing device 700. The aforementioned embodiments include, but not limited to personal computers, phones, servers, drones, and networking devices such as, but not limited to, hubs, switches, routers, modems, and firewalls.

Two nodes can be said are networked together, when one computing device 700 is able to exchange information with the other computing device 700, whether or not they have a direct connection with each other. The communication sub-module 762 supports a plurality of applications and services, such as, but not limited to World Wide Web (WWW), digital video and audio, shared use of application and storage computing devices 700, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 702, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 762 may comprise a plurality of size, topology, traffic control mechanism and organizational intent. The communication sub-module 762 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 702.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G.
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 700 may employ the sensors sub-module 763 as a subset of the I/O 760. The sensors sub-module 763 comprises at least one of the devices, modules, and subsystems whose purpose is to detect events or changes in its environment and send the information to the computing device 700. Sensors are sensitive to the measured property, are not sensitive to any property not measured, but may be encountered in its application, and do not significantly influence the measured property. The sensors sub-module 763 may comprise a plurality of digital devices and analog devices, wherein if an analog device is used, an Analog to Digital (A-to-D) converter must be employed to interface the said device with the computing device 700. The sensors may be subject to a plurality of deviations that limit sensor accuracy. The sensors sub-module 763 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter. Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge/force sensor, level sensor, load cell, magnetic level/nuclear density/strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 700 may employ the peripherals sub-module 762 as a subset of the I/O 760. The peripheral sub-module 764 comprises ancillary devices uses to put information into and get information out of the computing device 700. There are 3 categories of devices comprising the peripheral sub-module 764, which exist based on their relationship with the computing device 700, input devices, output devices, and input/output devices. Input devices send at least one of data and instructions to the computing device 700. Input devices can be categorized based on, but not limited to:
Modality of input, such as, but not limited to, mechanical motion, audio, and visual.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 700. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 764:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 700. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 700 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices covert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, and Refreshable Braille Display/Braille Terminal.
   Printers, such as, but not limited to, inkjet printers, laser printers, 3D printers, and plotters.
   Audio and Video (AV) devices, such as, but not limited to, speakers, headphones, and lights, which include lamps, strobes, DJ lighting, stage lighting, architectural lighting, special effect lighting, and lasers.
   Other devices such as Digital to Analog Converter (DAC).
Input/Output Devices may further comprise, but not be limited to, touchscreens, networking device (e.g., devices disclosed in network 762 sub-module), data storage device (non-volatile storage 761), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1-23. (canceled)

24. A method comprising:
receiving a plurality of campaign parameters for soliciting a plurality of consumers;
identifying, based on the plurality of campaign parameters, a consumer of the plurality of consumers to be solicited;
polling a plurality of commerce systems to identify at least one offer to be presented to the identified consumer based on a comparison of a plurality of variables, the plurality of variables comprising at least one of the following: a consumer profile of the identified customer, the campaign parameters, or the at least one offer;
receiving offer creation parameters for the at least one offer from at least one commerce system of the plurality of commerce systems;
communicating the at least one offer to the identified consumer, wherein communicating comprises employing natural language conversational dialog via a bi-directional messaging medium;
ascertaining whether the identified consumer desires to accept the at least one offer through the natural conversational dialog with the identified consumer;
creating, upon ascertaining acceptance, at least one order associated with the at least one offer, wherein creating the at least one order comprises at least one of the following:
identifying a commerce system associated with the at least one offer,
determining order parameters to be provided to the commerce system associated with the at least one offer, or
receiving the order parameters from at least one of the following:
a database associated with the plurality of commerce systems, or
the identified consumer through the natural language conversational dialogue over the bi-directional messaging medium;
processing the at least one order, wherein processing the at least one order comprises at least one of the following:
presenting the identified consumer, via the natural language conversational dialog over the bi-directional messaging medium, with the order parameters, or
ascertaining from the identified consumer, via the natural language conversational dialog over the bi-directional messaging medium, a confirmation of the at least one order;
determining whether payment information is available for the identified consumer;
obtaining, via the natural language conversational dialog over the bi-directional messaging medium, payment information responsive to a determination that the payment information is not available;
obtaining payment information associated with the identified consumer from a database in operative communication with a payment platform responsive to a determination that the payment information is available;
determining whether payment through the payment platform was successful, responsive to a determination that payment was not successful,
notifying the identified consumer via the natural language conversational dialog over the bi-directional messaging medium,
requesting new payment information via the natural language conversational dialog over the bi-directional messaging medium,
ascertaining the new payment information via the natural language conversational dialog over the bi-directional messaging medium, and
repeating payment success determination using the new payment information; and
responsive to a determination that payment was successful, confirming that payment has been processed, wherein confirming that payment has been processed comprises the following:
providing the identified consumer with a confirmation message, via the natural language conversational dialog over the bi-directional messaging medium, comprising order and payment details, and
tracking fulfillment of the at least one order, wherein tracking the fulfillment of the at least one order further comprises:
communicating the fulfillment of the at least one order to the commerce system for at least one of pick, pack or ship actions,
receiving updates from the commerce system, and
notifying, via the natural language conversational dialog over the bi-directional messaging medium, the identified consumer of the at least one of pick, pack or ship actions.

25. A method comprising:
polling a plurality of commerce systems for at least one order fulfillment request;
creating at least one order for the at least one order fulfillment request;
providing a consumer with the at least one order via a natural language conversational dialog over a bi-directional messaging medium;
processing the at least one order; and
causing fulfillment of the at least one order.

26. The method of claim 25, wherein processing the at least one order comprises:
providing the consumer with an ability to accept the at least one order by sending a designated reply via the natural language conversational dialog over the bi-directional messaging medium;
processing consumer payment; and
confirming the consumer payment has been processed via the natural language conversational dialog over the bi-directional messaging medium.

27. The method of claim 25, wherein causing fulfillment of the at least one order comprises:
communicating fulfillment of the at least one order to a commerce system of the plurality of commerce systems for at least one of pick, pack or ship actions; and
notifying the consumer of the at least one of pick, pack or ship actions via the natural language conversational dialog over the bi-directional messaging medium.

28. The method of claim 25, wherein the natural language conversational dialog over the bi-directional messaging medium comprises at least one of the following: email, text, SMS, or MMS.

29. The method of claim 25, wherein at least one of processing the at least one order or causing fulfillment of the at least one order is performed via the natural language conversational dialog over the bi-directional messaging medium.

30. The method of claim 25, wherein processing the at least one order comprises the following:
replying to the consumer via the natural language conversational dialog over the bi-directional messaging medium, wherein the reply contains a link to a payment platform;
receiving a selection from the consumer via the natural language conversational dialog over the bi-directional messaging medium indicating navigation to the link to the payment platform;
causing processing of the payment via the payment platform, from a plurality of payment platforms configured to process transactions between at least one consumer and at least one commerce system from the plurality of commerce systems; and
determining whether the payment was successful with the payment platform.

31. The method of claim 30, wherein causing processing of the payment further comprises:
determining whether the consumer is a new consumer or an existing consumer for the payment platform;
responsive to a determination that the consumer is a new consumer for the payment platform:
causing processing of the payment by requiring the consumer to enter personal and payment information; and
responsive to a determination that the consumer is a returning consumer to the payment platform:
causing processing of the payment without requiring the consumer to enter the personal and payment information.

32. The method of claim 30, wherein determining whether the payment was successful with the payment platform further comprises:
obtaining information on whether the payment was successful from the payment platform;
responsive to a determination that the payment was successful:
confirming the consumer payment has been processed; and
responsive to a determination that the payment was not successful:
notifying, via the natural language conversational dialog over the bi-directional messaging medium, the consumer that the payment has failed;
receiving, via the natural language conversational dialog over the bi-directional messaging medium, new payment information; and
repeating determining whether the payment was successful with the payment platform using the new payment information.

33. The method of claim 30, wherein determining whether the payment was successful with the payment platform further comprises at least one of:
providing the consumer with a confirmation page comprising order and payment details; or
sending a confirmation message via the natural language conversational dialog over the bi-directional messaging medium.

34. The method of claim 25, wherein polling the plurality of commerce systems for the at least one order fulfillment request comprises receiving offer creation parameters for the at least one order fulfillment request from at least one commerce system of the plurality of commerce systems.

35. The method of claim 25, wherein the plurality of commerce systems comprises at least one unaffiliated commerce system.

36. The method of claim 25, further comprising the use of the natural language conversational dialog over the bi-directional messaging medium for at least one of processing the at least one order or causing fulfillment of the at least one order.

37. The method of claim 25, wherein polling the plurality of commerce systems for the at least one order fulfillment request for comprises receiving the at least one order fulfillment request from at least one of advertisement, social media post, or QR code.

38. The method of claim 25, wherein the natural language conversational dialog over the bi-directional messaging medium is conducted using an Artificial Intelligence (AI) chatbot, which is designed to feel human.

39. The method of claim 25, further comprising providing historical data for analysis to at least one commerce system in the plurality of commerce systems.

40. The method of claim 39, wherein providing historical data for analysis to the at least one commerce system in the plurality of commerce systems comprises providing historical data related to at least one of average response rate, average click through rate, or open rate.

41. The method of claim 30, wherein causing processing of the payment comprises causing processing of the payment without receiving personal and payment information from the consumer.

42. The method of claim 25, wherein processing the at least one order further comprises determining at least one of order platform, payment platform or shipping platform.

43. The method of claim 25, wherein processing the at least one order and causing fulfillment of the at least one order comprises processing the at least one order and causing fulfillment of the at least one order without storing personal and payment information.
